(19) United States
(12) Patent Application Publication
(10) Pub. No.: US 2005/0058753 A1
(43) Pub. Date: Mar. 17, 2005

(54) Method to increase image variety with limited image components

(75) Inventor: Benito Alberto Romanach, Mason, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 10/941,408

(22) Filed: Sep. 15, 2004

Related U.S. Application Data
(60) Provisional application No. 60/503,717, filed on Sep. 17, 2003.

(51) Int. Cl. C12H 1/10

(52) U.S. Cl. 426/383

(57) ABSTRACT

An article of commerce comprising an edible substrate having a composite image disposed thereon, and a method for making edible substrates having a variety of different images.

### CROSS REFERENCE TO RELATED APPLICATIONS

This application claims the benefit of priority to U.S. Provisional Application Ser. No. 60/503,717, filed Sep. 17, 2003, which is herein incorporated by reference.

### FIELD OF INVENTION

The present invention relates to articles of commerce comprising a plurality of edible substrates, more particularly wherein the edible substrates have composite images disposed thereon.

### BACKGROUND OF THE INVENTION

Printing on edible items such as snacks can provide an added level of excitement beyond the snacking itself. The printed content can be in the form of graphics, text or combinations, and it can be used to deliver, for example, games, stories, jokes, and educational facts. This new level of excitement is, however, a function of how new the printed content is to the consumer. Such is the case, for example, of reading a joke for the second time. In this case the joke may not be effective any longer at creating an impact or sustaining the interest. Also, when being exposed to an image for the second time, a consumer may no longer be interested in it because she is already familiar with it. To sustain a high level of excitement upon consumption of printed edible items it is, therefore, important, to provide consumers with variety of content within a unit purchase and over multiple purchases.

This could be accomplished by a very large database of content from which to draw for printing. But this could be difficult to manage since all content would typically need to be reviewed and approved for use, and a system to store all content could be more complex. For example, stacked fabricated potato crisps like Pringles®, are a popular snack item sold as stacks of crisps within canisters, that lend themselves well for printing for having consistent planar surfaces that can be printed. However, billions of individual Pringles® crisps are sold every year. It would be very difficult to provide a database with printed content that would be unique for this many snack crisps, in order to provide consumers new printed content in every canister purchase. Furthermore, the licensing fees of images provided by content providers could potentially be much higher as a result of needing to use more varied content.

It would be, therefore, advantageous to devise methods to deliver new printed content consistently to consumers with every unit purchase. Furthermore, it would be advantageous to do so while minimizing the number of images used in the process.

### SUMMARY OF THE INVENTION

In one aspect, the present invention provides a method of making edible substrates having a variety of images disposed thereon. The value of the article can be enhanced and sustained by providing a variety of images to the consumer. Such variety leads in turn to a sustained level of consumer engagement and stimulation, increased product desirability, and also serves to build a stronger relationship between the article manufacturer and the consumer.

In one aspect, the present invention provides a method of making an edible substrate having an image disposed thereon, comprising:
(a) providing an edible substrate;
(b) providing a first sub-image source, wherein said first sub-image source comprises a plurality of sub-images;
(c) providing a second sub-image source, wherein said second sub-image source comprises a plurality of sub-images;
(d) selecting a first sub-image from the first sub-image source;
(e) selecting a second sub-image from the second sub-image source;
(f) forming a composite image, wherein said composite image comprises the first sub-image and the second sub-image;
(g) communicating the composite image to an image disposal device; and
(h) disposing said composite image on said edible substrate to form an image-disposed edible substrate.
   In another aspect, the present invention provides an article of commerce comprising:
An article of commerce comprising:
   (a) a container; and
   (b) a plurality of image-disposed edible substrates contained within said container, wherein at least one image-disposed edible substrate comprises a composite image disposed thereon; and
   (c) optionally, a message associated with the container, wherein said message communicates to the consumer that the image-disposed edible substrates contained within said container have different images disposed thereon.

These and other features, aspects, and advantages of the present invention will become evident to those skilled in the art from reading of the present disclosure.

All documents cited herein are incorporated by reference in their entirety. The citation of any document is not to be construed as an admission that it is prior art with respect to the present invention.

### BRIEF DESCRIPTION OF THE DRAWINGS

FIG. 1. FIG. 1 shows a source of sub-images. In this particular embodiment, these sub-images represent various hats.

FIG. 2. FIG. 2 shows a source of sub-images. In this particular embodiment, these sub-images represent various face shapes.

FIG. 3. FIG. 3 shows a source of sub-images. In this particular embodiment, these sub-images represent various pairs of eyes.

FIG. 4. FIG. 4 shows a source of sub-images. In this particular embodiment, these sub-images represent various noses.

FIG. 5. FIG. 5 shows a source of sub-images. In this particular embodiment, these sub-images represent various mouths.

FIG. 6. FIG. 6 shows a number of composite images formed from the sub-images of FIGS. 1-5.

FIG. 7. FIG. 7 shows two sub-images having registration points.

FIG. 8. FIG. 8 shows two sub-images that are aligned by their respective registration points.

### DETAILED DESCRIPTION OF THE INVENTION

1. Method

In one aspect, the present invention provides a method of making an edible substrate having an image disposed thereon, comprising:
(a) providing an edible substrate;
(b) providing a first sub-image source, wherein said first sub-image source comprises a plurality of sub-images;
(c) providing a second sub-image source, wherein said second sub-image source comprises a plurality of sub-images;
(d) selecting a first sub-image from the first sub-image source;
(e) selecting a second sub-image from the second sub-image source;
(f) forming a composite image, wherein said composite image comprises the first sub-image and the second sub-image;
(g) communicating the composite image to an image disposal device; and
(h) disposing said composite image on said edible substrate to form an image-disposed edible substrate.

a. Edible Substrate

As used herein, “edible substrate” or “substrate” includes any material suitable for consumption that is capable of having an image disposed thereon. Any suitable edible substrate can be used with the invention herein. Examples of suitable edible substrates can include, but are not limited to, snack chips (e.g., sliced potato chips), fabricated snacks (e.g., fabricated chips such as tortilla chips, potato chips, potato crisps), extruded snacks, cookies, cakes, candy, bread, fruit, dried fruit, beef jerky, crackers, pasta, sliced meats, sliced cheese, pancakes, waffles, dried fruit film, breakfast cereals, and toaster pastries.

In a preferred embodiment, the edible substrate comprises a fabricated snack piece, preferably a fabricated snack chip, and more preferably a fabricated potato crisp. Suitable snack pieces include those described in “Chip Frying Machine,” U.S. Pat. No. 3,520,248, issued Jul. 14, 1970, to MacKendrick; “Preparation of Chip-Type Products,” U.S. Pat. No. 3,576,647, issued Apr. 27, 1971, to Liepa; “Apparatus for Preparing Chip-Type Products,” U.S. Pat. No. 3,608,474, issued Sep. 28, 1971, to Liepa; and “Molding Device for Preparing Chip-Type Products,” U.S. Pat. No. 3,626,466, issued Dec. 7, 1971, to Liepa; Lodge in U.S. Pat. No. 5,464,643, and Villagran et al. in U.S. Pat. No. 6,066,353 and U.S. Pat. No. 5,464,642. In one embodiment, the fabricated snack chip is a fabricated potato crisp, such as that described by Lodge in U.S. Pat. No. 5,464,643, and Villagran et al. in U.S. Pat. No. 6,066,353 and U.S. Pat. No. 5,464,642. Other snack chips that can be used herein include those described in “Process for Making a Corn Chip with Potato Chip Texture,” U.S. Pat. No. 4,645,679, issued Feb. 24, 1987 to Lee, III et al.

In addition, the edible substrate can include pet foods such as, but not limited to, dog biscuits and dog treats.

The edible substrate can be in any suitable form. For example, the substrate can be a finished food product ready for consumption, a food product that requires further preparation before consumption (e.g., snack chip dough, dried pasta), or combinations thereof. Furthermore, the substrate can be rigid (e.g., fabricated snack chip) or non-rigid (e.g., dried fruit film, dough sheet). In one embodiment, the edible substrates are connected to one another (e.g., in the form of a dough sheet prior to cutting the individual pieces).

As used herein, “fabricated snack piece” or “snack piece” is broad enough to include a snack piece that has not yet been separated (e.g., cut) from a dough. For example, in one embodiment, an image is disposed upon a dough sheet, then the dough sheet is later cut into individual pieces. Furthermore, “fabricated snack piece” or “snack piece” is broad enough to include both cooked (e.g., fried) and un-cooked (e.g., dough) substrates.

Preferably, the edible substrates are provided as a stream of substrates. As used herein, “stream” means a continuous source of substrates. For example, a stream of substrates can include a plurality of substrates such as that provided by a conveyor belt or as a feed from a continuous, semi-continuous, or batch process.

b. Sub-Image Source

As used herein, “sub-image” means a text or graphic that is used in combination with at least one other text or graphic to form a composite image. It should be noted herein that a sub-image may be either textual (i.e., comprising text) and/or graphical (i.e., comprising one or more graphics or pictorial representations). As used herein a “sub-image source” includes any collection of one or more sub-images that can be used to form a composite image. For example, the sub-image source can be an electronic (e.g., computer-based) database, a plurality of databases, or a collection of hard-copy images.

Sub-images can be in any suitable form, preferably electronic media such as that generated using computer software and stored on an electronic storage device, such as a computer, computer disk, RAM, or ROM, or visual display. Any suitable computer system, as known in the art, can be used.

Preferably, all the sub-images in the sub-image source are different from one another. However, in one embodiment, at least two of the sub-images in a sub-image source are the same.

Preferably, each sub-image can be identified by an identifier, e.g., a sequential number or letter, that allows the sub-image to be selected from the sub-image source. For example, in one embodiment, each sub-image is identified by a unique number (e.g., 100 sub-images are each assigned a different number from 1 to 100). Assigning an identifier to each sub-image allows for, among other things, cataloging of sub-images and selection of sub-images from the source by identifier (e.g., by number or letter). In another embodiment, an identifier is assigned to a portion or a cluster of sub-images.

Any suitable sub-image can be used. The sub-image can comprise one or more graphic elements, one or more text elements, or combinations thereof. As used herein, “text” means one or more alpha-numeric symbols or parts thereof. Text can include letters, numbers, words, or combinations thereof.

As used herein, “graphic” means pictorial representation. For instance, the graphic can include objects, symbols, scenes, people, animals, toys, photographs, pictures, puzzles, or characters or parts thereof. Suitable characters can include cartoon characters and licensed characters, as well as characters associated with popular personalities in the media, advertising, or well known in the particular culture.

Herein, sub-images can be or use text in the form of full or partial words, numbers, clues, hints, jokes, revelations, trivia quizzes, stories, games, or sequence of events (e.g., animations). For example, the sub-image can comprise the question portion of a trivia quiz. In one embodiment, the sub-image depicts a piece of a jig-saw puzzle. Of course, a combination of both text and graphics are possible.

Furthermore, the sub-image can be permanent or active. Permanent sub-images include those that do not change before consumption of the edible substrate. Active sub-images include those that can be modified by some means before consumption of the edible substrate.

For example, active sub-images include those that can be visually modified. In one embodiment, an invisible sub-image becomes visible when the substrate comes into contact with saliva (e.g., the substrate is licked). In another embodiment, the sub-image becomes visible when the substrate is held under a black light source. In yet another embodiment, the visible sub-image becomes invisible when the substrate comes into contact with saliva. In still another embodiment, the visible sub-image disappears and a second, different, sub-image appears when the substrate comes into contact with saliva.

As used herein, “sub-images” or “plurality of sub-images” also includes a continuous sub-image source (e.g., a ribbon or band) that is disposed on or across multiple substrates. For example, in one embodiment, different, discrete portions of a sub-image (e.g., a chain or row of flowers) are disposed on a plurality of substrates. Thus, according to the present invention, a continuous sub-image source can provide the source of multiple sub-images.

C. Composite Image

As used herein, a “composite image” comprises a plurality of sub-images. The sub-images that form the composite image can be arranged in any suitable format. For example, the sub-images can be related or unrelated in subject matter; can be arranged contiguously, non-contiguously, or over-lapping; or can be arranged in a pre-determined way as a function of each of the sub-images (e.g., placement of facial features where sub-images are parts of a face). In one embodiment where the composite image is a face, sub-images that comprise the face can include a head, a mouth, eyes, a nose, glasses, hair, and a hat; the sub-image sources include a plurality of heads, mouths, eyes, noses, glasses, hair, and hats, respectively, from which composite images can be formed.

In a particular embodiment, sub-images have pre-determined registration points that enable proper registration of one sub-image with another sub-image to form the desired composite image. For example, the placement of a hat sub-image on a head sub-image, or the placement of an eyes sub-image on a face sub-image. In the case of placing a hat sub-image on a head sub-image, the hat sub-image includes information (e.g., particular designated point or points) that corresponds to information on the head sub-image (e.g., corresponding designated point or points) that directs placement of one in relation to the other. Preferably, the registration points are not visible upon disposing the composite image upon the edible substrate, but are stored as information associated with the sub-images.

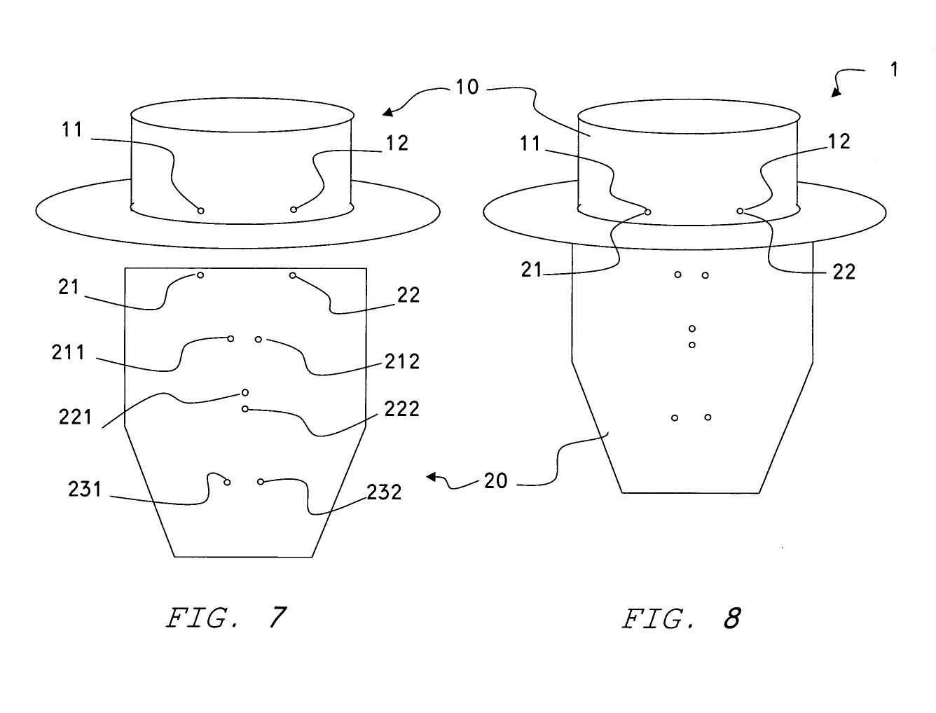

For example, FIG. 7 shows two sub-images (10 and 20) having registration points. Sub-image (10) has registration points (11 and 12). Sub-image (20) has registration points (21 and 22). Registration point (11) corresponds to registration point (21). Registration point (12) corresponds to registration point (22). FIG. 8 shows sub-images (10 and 20) aligned by their corresponding registration points. FIG. 7 shows additional registration points (211, 212, 221, 222, 231, and 232) of sub-image (20) that may be used to align sub-images from different sub-image sources.

In another embodiment, sub-images are assigned to a particular foreground priority. Those sub-images having a lower foreground priority are disposed such that portions that would otherwise overlap with higher foreground priority sub-images are not disposed. This can avoid undesirable overlap of various sub-images in a composite image (e.g., avoid disposal of part of a mountain range on top of a character with a higher foreground priority).

The composite image can comprise single or multi-color sub-images; thus, the composite image can be either single or multi-color. The composite image can be any suitable combination of sub-images. For example, the composite image can comprise a landscape sub-image, a character sub-image, and an object sub-image. In one embodiment, the composite image comprises a beach sub-image wherein a star-fish character sub-image is sitting under an umbrella sub-image. In another embodiment, the composite image comprises the same beach sub-image wherein a dog sub-image is chasing a stick sub-image.

In another embodiment, each specific sub-image from a sub-image source is connected to information that communicates the compatibility of that particular sub-image with other particular sub-images. For example, a sub-image from a landscape sub-image source (e.g., beach, city, park, building, mountains sub-images) is combined with sub-images from a character sub-image source (e.g., star-fish, dog, cat, boy sub-images). In order to provide suitable combinations of landscape sub-images with character sub-images, information is provided that associates each landscape sub-image with each compatible character sub-image. For example, the mountain sub-image is associated with the dog, cat, and boy sub-images, but not with the star-fish sub-image. Thus, composite images comprising both the mountain sub-image and the star-fish sub-image are not created.

d. Image Disposal

According to the present invention, the composite images are communicated to an image disposal device. The image disposal device disposes a composite image on an edible substrate to form an image-disposed edible substrate. As used herein, an “image-disposed edible substrate” is an edible substrate having a composite image disposed thereon (“disposed image”). The disposed image can cover part or all of the visual portion of the edible substrate.

As used herein, “disposed on” means that one element can be integral with another element, or that one element can be a separate structure bonded to or placed on another element. Thus, the composite image can be applied directly or indirectly to the edible substrate, applied to a material that is placed on the edible substrate, applied within the edible substrate, or other variations or combinations thereof. In particular embodiments, the composite image can be printed, sprayed, or other wise applied directly on the surface of the substrate. In other embodiments, the composite image can be applied to a material placed on the surface of the substrate. The composite image can be located on the outer surface of the substrate, or can be located on the interior of the substrate, or combinations thereof.

Any suitable means of disposing a composite image on the substrate can be used herein. For example, the composite image can be printed, drawn, painted, or otherwise attached to the edible substrate. The composite image can be single-color or multi-color. The composite image can comprise dyes, pigments, other natural or synthetic substances, or combinations thereof.

The composite image can be disposed on the edible substrate before or after a cooking process (e.g., before or after a dough sheet is baked or fried). Furthermore, the composite image can be disposed on the edible substrate before or after it is cut into individual pieces (e.g., before or after a dough sheet is cut into individual cookie or snack chip pieces).

In one embodiment, the composite image is printed on the substrate. Methods of printing can include, but are not limited to, laser, ink jet (e.g., thermal bubble jet, piezoelectric drop on demand, continuous ink jet), gravure, flexographic, and stamping.

In another embodiment, an edible sticker comprising a composite image is affixed to the substrate.

In another embodiment, a thin film comprising a composite image is affixed to the substrate via edible adhesive.

In a preferred embodiment, an ink jet composite image is printed on a fabricated snack chip.

In one embodiment, more than one surface of the edible substrate has a composite image disposed thereon. For example, a plurality of image disposal devices can be employed, each one to dispose an image on different sides of the edible substrate (e.g., top, bottom, and/or side)

In a preferred embodiment, the sides of a plurality of edible substrates each have a composite image disposed thereon, such that when the edible substrates are stacked in a particular order one upon the other, a graphic or text display is formed on the side of the collective stack.

In one embodiment, the image disposal device comprises a printer. Preferably, digital printing is used, such as ink-jet printing systems (e.g., continuous jet, drop-on-demand), such as those described in WO 01/94116 by Willcocks et al., published Dec. 13, 2001. In a preferred embodiment, an ink-jet printer disposes composite images on a dough sheet, which is cut into individual pieces then fried to form fabricated snack chips.

2. Article of Commerce

In another aspect, the present invention provides an article of commerce comprising:
(a) a container; and
(b) a plurality of image-disposed edible substrates contained within said container, wherein at least one image-disposed edible substrate comprises a composite image disposed thereon; and
(c) optionally, a message associated with the container, wherein said message communicates to the consumer that the image-disposed edible substrates contained within said container have different images disposed thereon.

The present invention answers the need for a method that can provide a variety of images disposed on edible substrates (unlike rotary or flexographic printing). This method makes possible an article of commerce comprising a large variety of image-disposed edible substrates by using a limited number of sub-images. For example, where three sets of sub-images, each set comprising 10 different sub-images, are combined to form composite images, the potential number of different composite images that can be created is 1000 (10×10×10); by using only 30 different sub-images, 1000 different composite images can potentially be created. In one embodiment, three sets of sub-images are combined in various combinations to form composite images, each comprising one sub-image from each set; one set comprises 80 face sub-images, one set comprises 123 eye sub-images, and one set comprises 74 mouth sub-images. The combination of these 277 (80+123+74=277) sub-images results in a potential of 728,160 (80×123×74=728,160) different composite images.

The article can optionally comprise a message associated with the container. In one embodiment, the message communicates to the consumer that all of the image-disposed edible substrates contained within said container have a different image disposed thereon. In another embodiment, the message communicates to the consumer that articles in a particular location (e.g., the consumer's store shelf) have different images.

In one embodiment, a container comprises a plurality of edible substrates, wherein more than one edible substrate in said container comprises the same composite image. (e.g., at least two the same)

In another embodiment, a container comprises a plurality of edible substrates, wherein at least one edible substrate comprises a composite image. (e.g., at least one printed potato crisp in a container)

In another embodiment, a container comprises a plurality of edible substrates, wherein at least two edible substrates have composite images disposed thereon. At least two of the edible substrates have composite images that are different from one another.

The article of commerce comprises a container for containing said edible substrates. Any container from which the edible substrates can be dispensed, presented, displayed, or stored is suitable. Suitable containers include, but are not limited to, bags, canisters, boxes, bowls, plates, tubs, cups, paper wrappers, and cans.

In one embodiment, the container is a round cylindrical canister that can contain uniformly-shaped fabricated potato crisps. Suitable such containers can include those described in “Packaging of Chip-Type Snack Food Products,” U.S. Pat. No. 3,498,798, issued Mar. 3, 1970, to Bauer et al.; and “Container Having a Membrane-Type Closure,” U.S. Pat. No. 3,973,719, issued Aug. 10, 1976, to Johnson, et al.

### EXAMPLE 1

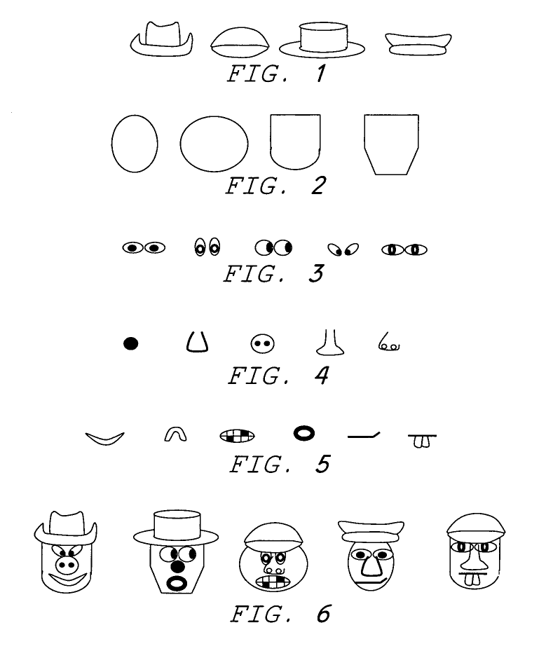

FIGS. 1-5 show various sources of sub-images. FIG. 6 shows various composite images that can be created using the sub-images of FIGS. 1-5.

### EXAMPLE 2

In another example, the sub-image sources comprise a variety of portions of sentences that can be combined to form full sentences. A first sub-image source comprises images of the following portions of sentences: “My neighbor's dog”, “My best friend”, and “The postman”. A second sub-image source comprises images of the following portions of sentences: “needed me to”, “wanted me to”, and “forced me to”. A third sub-image source comprises images of the following portions of sentences: “teach him to use a mouse”, “prepare a book report”, and “take some pictures”. A fourth sub-image source comprises images of the following portions of sentences: “in the airport”, “in the street”, and “over breakfast”. One sub-image from each sub-image source are combined to form an image of a full sentence. For example an image may comprise four sub-images which when combined result in the following text: “My best friend needed me to take some pictures over breakfast”. In this example, twelve sub-images (i.e., three sub-images in each of four sub-images sources), can result in eighty one possible sentences.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of making an edible substrate having an image disposed thereon, comprising:
(a) providing an edible substrate;
(b) providing a first sub-image source, wherein said first sub-image source comprises a plurality of sub-images;
(c) providing a second sub-image source, wherein said second sub-image source comprises a plurality of sub-images;
(d) selecting a first sub-image from the first sub-image source;
(e) selecting a second sub-image from the second sub-image source;
(f) forming a composite image, wherein said composite image comprises the first sub-image and the second sub-image;
(g) communicating the composite image to an image disposal device; and
(h) disposing said composite image on said edible substrate to form an image-disposed edible substrate.

2. The method of claim 1 wherein the first sub-image is graphical.

3. The method of claim 1 wherein the second sub-image is graphical.

4. The method of claim 1 wherein the first and the second sub-images are graphical.

5. The method of claim 1 wherein the first sub-image is textual.

6. The method of claim 1 wherein the second sub-image is textual.

7. The method of claim 1 wherein the first and second sub-images are textual.

8. The method of claim 1 wherein the first sub-image is graphical and the second sub-image is textual.

9. An article of commerce comprising:
(a) a container; and
(b) a plurality of image-disposed edible substrates contained within said container, wherein at least one image-disposed edible substrate comprises a composite image disposed thereon; and
(c) optionally, a message associated with the container, wherein said message communicates to the consumer that the image-disposed edible substrates contained within said container have different images disposed thereon.

10. The method of claim 9 wherein the composite image comprises one or more graphical sub-images, textual sub-images or combinations thereof.
